(19) United States
(12) Patent Application Publication
(10) Pub. No.: US 2007/0226012 A1
(43) Pub. Date: Sep. 27, 2007

(54) METHODS OF MEASURING SYMPTOMS OF CHRONIC RHINOSINUSITIS

(75) Inventors: Kimberly SALGADO, Santa Barbara, CA (US); Jenna ELDER, Wilmington, NC (US); Theresa NEUMANN, Menlo Park, CA (US); Martin CITARDI, Solon, OH (US); Jim HINSON, Brentwood, TN (US); Gina ROSSEN, Santa Barbara, CA (US); Winston VAUGHAN, E. Palo Alto, CA (US)

Correspondence Address: WILSON SONSINI GOODRICH & ROSATI, 650 PAGE MILL ROAD, PALO ALTO, CA, 94304-1050, US

(73) Assignee: Naryx Pharma, Inc., Carpinteria, CA (US)

(21) Appl. No.: 11/610,391

(22) Filed: Dec. 13, 2006

Related U.S. Application Data
(60) Provisional application No. 60/750,008, filed on Dec. 13, 2005.

(51) Int. Cl. G06F 19/00

(52) U.S. Cl. 705/3; 434/322

(57) ABSTRACT

A method for diagnosing, assessing, and determining of the efficacy of a treatment regimen for chronic rhinosinusitis is presented. The method comprises collecting subjective information from a patient or patient population in the form of patient entries into a daily diary, wherein the daily diary comprises the patient responses to questions directed to the presence or absence of a group of clinical signs and symptoms related to chronic rhinosinusitis. Based upon the patient responses in the daily diaries, certain of the clinical signs and symptoms are identified for use in the generation of a scoring tool useful in the determination and assessment of the efficacy of a treatment regimen for chronic rhinosinusitis, as well as in the clinical determination of the severity of the symptoms related to chronic rhinosinusitis.

### FIELD OF THE INVENTION

A method for diagnosing, assessing, and determining of the efficacy of a treatment regimen for chronic rhinosinusitis is presented. The method comprises collecting subjective information from a patient or patient population in the form of patient entries into a daily diary, wherein the daily diary comprises the patient responses to questions directed to the presence or absence of a group of clinical signs and symptoms related to chronic rhinosinusitis. Based upon the patient responses in the daily diaries, certain of the clinical signs and symptoms are identified for use in the generation of a scoring tool useful in the determination and assessment of the efficacy of a treatment regimen for chronic rhinosinusitis, as well as in the clinical diagnosis of chronic rhinosinusitis.

### BACKGROUND OF THE INVENTION

The present invention is related to conditions of the sinuses and nasal passages, and more specifically to a system and method for diagnosis and treatment of chronic rhinosinusitis conditions in humans.

The human sinuses are composed of four paired, sterile cavities lined with ciliated epithelium. Inflammation of the sinuses is generally described as sinusitis. Rhinosinusitis is an inflammatory disease of the nasal cavities, fluids within these cavities, the paranasal sinuses, and/or the underlying bone. While the exact etiology is unknown, it is believed that rhinosinusitis can involve one or more host factors (e.g. allergic, immunodeficiency, genetic/congenital, mucociliary dysfunction, endocrine, neuromechanism, anatomic, or neoplastic) and/or environmental factors (e.g., microorganisms [virus, bacteria, and fungi], noxious chemicals, latrogenic medication/surgery, or trauma). It is known that chronic rhinosinusitis can manifest through a variety of physical symptoms. These symptoms include, but are not limited to: nasal obstruction; nasal congestion; facial and/or sinus pain; facial and/or sinus pressure; nasal discharge/purulence; hyposmia/anosmia; discolored post nasal drip; headache; sinus headache; tiredness/fatigue; fever; cough; ear pain; halitosis; and dental pain.

Classification of rhinosinusitis is described as acute, sub-acute, acute-recurrent, and chronic (CRS), based on the length of symptoms. Acute rhinosinusitis describes patients having symptoms for 4 weeks or less with complete resolution of symptoms either spontaneously or with treatment. Sub-acute rhinosinusitis involves symptoms that persist for more than 4 weeks but less than 8 weeks. Chronic rhinosinusitis (also known as chronic sinusitis) is defined as a group of clinical disorders with accompanying nasal and paranasal sinus mucosa inflammation of at least 8 consecutive weeks (or greater than about 60 days) despite therapy.

The United States Centers for Disease Control and Prevention surveys estimate that approximately 33 million persons in the United States suffer from chronic rhinosinusitis each year, with the prevalence of the disease increasing. Additionally, chronic rhinosinusitis has been shown to affect urban populations from 5% of the population up to 15% of the population. Most rhinosinusitis cases occur after an upper respiratory viral infection. Viral infections impair the sinus epithelium, which in turn promotes dysfunctional ciliary and a massive inflammation ensues. Mucostasis is created by the ciliary dysfunction, and the injured epithelium becomes highly susceptible to secondary bacterial invasion from the contiguous nasal passages. Occlusion of the ostiomeatal complex develops from inflammation, sinus drainage is obstructed and creating a hypoxic, hypercarbic, acidic environment is created which is conducive to the growth of bacteria.

Other than an upper respiratory viral infection, there are multiple factors that lead to the development of rhinosinusitis, including: dental infection, occlusion of the ostiomeatal complex, ciliary dysfunction, and immunodeficiency. Infectious rhinosinusitis can be of viral, bacterial, or fungal origin. Although the bacterial cause of chronic rhinosinusitis is not specifically outlined, frequently implicated species are anaerobes, gram negatives, and staphylococcal.

Acute sinusitis has highly variable clinical presentations. Most of the primary symptoms are nonspecific and can include: nasal congestion, purulent nasal discharge, headache, facial pressure, dental pain, fever, cough, tiredness/fatigue, halitosis, or a diminished sense of smell. The duration of symptoms becomes critical during diagnosis because such symptoms are very similar to those of a viral upper respiratory infection. A patient with cold-like symptoms that are not resolved after 7 to 10 days has a high likelihood of having acute bacterial sinusitis. The symptoms in adults and children of chronic rhinosinusitis can present themselves similarly to acute sinusitis, but clinical presentations tend to be more vague and less severe.

Because there are no current rigid criteria that define sinus disease, there is little data on the exact pathophysiology of rhinosinusitis. The clinical presentations of rhinosinusitis can easily be diagnosed as stemming from other conditions. The rhinosinusitis symptoms of congestion and nasal discharge can be closely associated with other causes, such as viral upper respiratory infections, allergic rhinitis, nasal polyps, cocaine abuse, rhinitis medicamentosa, and vasomotor rhinitis. Additionally, the rhinosinusitis clinical presentation of facial pain can stem from tension, cluster, and migraine headaches, as well as dental disease.

Currently, there are no Food and Drug Administration (FDA) approved medicines that are specifically designed to treat chronic rhinosinusitis. However, the current standard of care for the disorder includes the use of anti-inflammatory medications, antibiotics, decongestants, saline solutions, allergy treatments, and surgery (such as functional endoscopic sinus surgery (FESS)). The aim of most treatments is an improvement in the patient's clinical signs and symptoms. It is therefore important to employ methods best suited for capturing the effect of treatment on the patient's experience with the symptoms.

Diagnosis of chronic rhinosinusitis involves subjective reports and empirical measures. The patient suffering from chronic rhinosinusitis usually offers a subjective description of their condition while physical factors, such as sinus inflammation and obstruction, can be objectively measured. Additional diagnostic tools can aid diagnosis, such as a computed tomography (CT) or nasal endoscopy.

While two of the symptoms of CRS cannot be reliably assessed using a patient's subjective report: (i) the presence of purulence in the nasal cavity; and (2) hyposmia/anosmia, the many of the remaining symptoms, e.g., facial and/or sinus pressure, facial and/or sinus pain, nasal congestion, and post-nasal drip; can be most accurately evaluated using a subjective approach and are therefore best captured by the patient's subjective report. Accordingly, an instrument capable of assessing subjective evaluation of such symptoms would be especially valuable in the assessment of CRS.

Thus, the creation of a patient-reported questionnaire for use in evaluating the change in clinical status of chronic rhinosinusitis over the course of a treatment regimen would greatly assist in reaching an effective end-point health care experience for chronic rhinosinusitis sufferers.

Other methods have been previously described to determine patient-reported outcomes (PRO) as related to CRS utilizing a survey and/or a questionnaire. The Chronic Sinusitis Survey—Duration-Based (CSS-D) and Severity-Based (CSS-S)—utilized questionnaires for subjective evaluation of certain symptoms by the patient population. See for example, Gilklich et al., Laryngoscope 105:387-390 (1995). The CSS-D asked patients to recall the number of weeks in an 8-week period during which they suffered a particular symptom, regardless of severity or side, and the number of weeks in that period during which the patients used various types of medications. The CSS-S asked patients to score severity of symptoms on each side of the patient's nose or face using a scale of 0 to 4. The CCS-D was found to be a reliable method of PRO. However, the severity-based survey (CCS-S) was found to be unreliable based upon test-retest analysis.

The Rhinosinusitis Outcome Measure-31 (RSOM-31) was designed as a 62 item self administered symptom impact measure. See Linder et al., J Gen Inter Med 18:390-401 (2003). Within the 62 items surveyed, an additional 7 subscales were provided based on: nasal, eye, ear, sleep, general, practical, and emotional.

The Sino Nasal Outcome Test-16 (SNOT-16) is a symptom impact measurement tool derived from the SNOT-20 test. SNOT-20 assessed symptom impact in 5 subscales: nasal, paranasal, sleep, social, and emotional. See Linder et al., J Gen Inter Med 18:390-401 (2003).

The three questionnaire-based PRO instruments demonstrated satisfactory results regarding psychometric properties and symptom impact of CRS populations, but none of these PROs provide a reliable specific evaluation of a disease-specific symptom severity measure in CRS.

In addition, the FDA has developed a scored survey as it pertains to diagnosing allergic rhinitis, called the Total Nasal Symptom Score (TNSS). The TNSS has been used and accepted as a primary endpoint in clinical trials for FLONASE and other products designed to treat allergic rhinitis (FDA Guidance for Industry document for Allergic Rhinitis: Clinical Development Programs for Drug Products).

Consequently, there is a need for a simple, reliable, and easy-to-understand method for a patient to quantify the presence or absence of clinical signs and symptoms related to chronic rhinosinusitis to determine the efficacy of specific chronic sinusitis treatment regimens. The methods described herein address this need through the statistical identification of certain of clinical signs and symptoms related to chronic rhinosinusitis for use in the generation of a scoring tool which enables the determination and assessment of the efficacy of a treatment regimen for chronic rhinosinusitis, as well as a method for clinical diagnosis of chronic rhinosinusitis, based upon patient reported outcomes. Since the duration of symptoms is important for the diagnosis of sinusitis, the methods will enable physicians to diagnose a patient with sinusitis, and can be used to discern whether the patient has acute or chronic rhinosinusitis. The methods can be utilized at the onset of treatment and throughout the course of treatment to determine the severity, status, and progression of chronic rhinosinusitis in a patient.

### SUMMARY OF THE INVENTION

The present invention in its basic form is a method to numerically score and report symptoms of chronic rhinosinusitis wherein the scores are representative of the presence and/or severity of the chronic rhinosinusitis symptoms and the reported values of the scores are used to evaluate the clinical status of chronic rhinosinusitis in a patient or patient population.

The invention in its broader aspects can be a method for determining the efficacy of a treatment regimen for treating chronic rhinosinusitis, said method comprising the steps of: (a) conducting at least two interviews of one or more a patients over the duration of a treatment regimen to collect patient-reported information specific to clinical severity of one or more of a plurality of symptoms related to chronic rhinosinusitis; (b) the at least two interviews comprising one or more patients assigning an individual symptom score for each of the one or more symptoms within the plurality of symptoms at the time of said interviews; (c) selecting two or more individual symptoms of plurality of symptoms for use in calculating a composite score which reflects clinical status of said chronic rhinosinusitis in said one or more patients at the time said interview was conducted; (d) calculating a composite score based upon the value of the two or more individual symptoms selected in step (c) to obtain a sum value which reflects the clinical status of chronic rhinosinusitis in the patient at the initiation of the treatment regimen; (e) calculating a composite score based upon the value of said two or more individual symptoms selected in step (c) to obtain a sum value which reflects the clinical status of chronic rhinosinusitis in the patient at a time point after the initiation of the treatment regimen; and (f) comparing sum values of steps (d) and (e) to determine the efficacy of the treatment regimen.

In certain embodiments, the methods can determine the efficacy of treatment regimens comprising the administration of an active agent at a specific dosage for the treatment of chronic rhinosinusitis over a defined period of time. In other embodiments, the methods can be used to compare the efficacy of one or more distinct dosages of an active agent in treating chronic rhinosinusitis. In still another embodiment, the present methods can be used to compare the efficacy of one or more distinct active agents in treating chronic rhinosinusitis.

The invention in its broader aspects can be a method for the assessment of chronic rhinosinusitis, said method comprising the steps of: (a) conducting at least two interviews of one or more a patients over the duration of a treatment regimen to collect patient-reported information specific to clinical severity of one or more of a plurality of symptoms related to chronic rhinosinusitis; (b) the at least two interviews comprising one or more patients assigning an individual symptom score for each of the one or more symptoms within the plurality of symptoms at the time of the interviews; (c) selecting two or more individual symptoms of plurality of symptoms for use in calculating a composite score which reflects clinical status of chronic rhinosinusitis in the one or more patients at the time the interview was conducted; (d) calculating a composite score based upon the value of the two or more individual symptoms selected in step (c) to obtain a sum value which reflects the clinical status of chronic rhinosinusitis in the patient at the initiation of the treatment regimen (e.g. the run-in period of the treatment regimen); (e) calculating a composite score based upon the value of the two or more individual symptoms selected in step (c) to obtain a sum value which reflects the clinical status of chronic rhinosinusitis in the patient at a time point after the initiation of the treatment regimen (e.g. the patient follow-up period of the treatment regimen); and (f) comparing sum values of steps (d) and (e) to assess chronic sinusitis in the one or more patients.

In certain embodiments, the assessment of chronic rhinosinusitis comprises assessing the response of a patient to a particular treatment regimen. In other embodiments, the assessment of chronic rhinosinusitis comprises assessing the response of a patient population to a particular treatment regimen. In one embodiment, the assessment of chronic rhinosinusitis further comprises calculating the difference between a mean composite score in a patient population and a previously calculated mean composite score in the same patient population.

In certain aspects of the present invention, the methods of assessment can further comprising the step of comparing the composite scores of step to a previously calculated composite score from the same patient. In one embodiment, the method of assessment comprises calculating the difference between the composite score and a previously calculated composite score from the same patient.

The invention in its broader aspects can be a method for the determining the severity of symptoms related to chronic rhinosinusitis, said method comprising: (a) conducting at least two interviews of with a patient over the duration of a predetermined period of time to collect patient-reported information specific to the clinical severity of one or more of a plurality of symptoms related to chronic rhinosinusitis; (b) the at least two interviews comprising the patient assigning an individual symptom score for each of the one or more symptoms within the plurality of symptoms at the time of the interview; (c) selecting two or more individual symptoms of the plurality of symptoms for use in calculating a composite score which reflects clinical status of chronic rhinosinusitis in the patient at the time said interview was conducted; (d) calculating a composite score based upon the value of the two or more individual symptoms selected in step (c) to obtain a sum value which reflects clinical status of chronic rhinosinusitis in the patient at the time of the first interview; (e) calculating a composite score based upon the value of the two or more individual symptoms selected in step (c) to obtain a sum value which reflects clinical status of chronic rhinosinusitis in the patient at a time point after the first interview; and (f) comparing sum values of steps (d) and (e) to determine the severity of the symptoms related to chronic rhinosinusitis in the patient.

In certain embodiments, the methods for diagnosis can further comprise comparing the composite score to known diagnostic criteria. In certain other embodiments, comparing the composite score to known diagnostic criteria further comprises statistical analyses.

In certain other embodiments, the methods for diagnosis can further comprise comparing the composite score to known diagnostic criteria in a lookup table. In one embodiment, the methods further comprise determining whether chronic rhinosinusitis in a patient is in a mild, moderate, or severe stage of disease progression.

In certain embodiments of the present invention, the interviews are conducted daily over the duration of the treatment regimen. In other embodiments, the interviews are conducted daily over the duration of a predetermined period of time.

The interviews comprise collecting patient-reported information in the form of responses to a set of questions related to clinical symptoms associated with chronic rhinosinusitis. The patient-reported information can be obtained through any means of data collection. In certain embodiments, the interviews comprise collecting patient-reported information in the form of responses to a set of oral questions, collecting patient-reported information in the form of responses to a set of questions contained in written questionnaire, collecting patient-reported information in the form of responses to a set of questions in a telephone survey (e.g., an Interactive Voice Response System (IVRS), collecting patient-reported information in the form of responses to a set of questions in fax survey, collecting patient-reported information in the form of responses to a set of questions in an Internet questionnaire to be submitted via the Internet, or by having said one or more patients directly input their responses to a set of questions contained in a questionnaire into a computer database, such as an Electronic Data Capture (EDC) system. In one embodiment, the interviews comprise collecting patient-reported information in the form of patient responses to a set of questions contained in a written questionnaire. In another embodiment, the interviews comprise collecting patient-reported information in the form of patient responses to a set of questions contained in a telephone survey mediated via an Interactive Voice Response System. In yet another embodiment, the interviews comprise collecting patient-reported information in the form of patient responses to a set of questions contained in an Electronic Data Capture system.

In certain embodiments of the present invention, the plurality of symptoms related to chronic rhinosinusitis comprises at least one of facial or sinus pressure, facial or sinus pain, nasal congestion, anterior nasal discharge, posterior nasal discharge/post nasal drip, headache, sinus headache, cough, earache or ear fullness, dental pain, halitosis, tiredness/fatigue, or any combination thereof. In one embodiment, the plurality of symptoms related to chronic rhinosinusitis comprises at least one of facial or sinus pressure, facial or sinus pain, nasal congestion, postnasal drip, sinus headache, and tiredness/fatigue. In another embodiment, the plurality of symptoms related to chronic rhinosinusitis comprises at least one of facial or sinus pressure, facial or sinus pain, anterior nasal discharge, posterior nasal discharge/post nasal drip, nasal congestion, sinus headache, and tiredness/fatigue. In yet another embodiment, the plurality of symptoms related to chronic rhinosinusitis comprises at least one of facial or sinus pain, cough, earache or ear fullness, nasal congestion, and dental pain.

In certain other embodiments, the individual symptom score comprises a subjective self-assessment of the symptom translated to a number for each of said plurality of symptoms related to chronic rhinosinusitis. In one embodiment, the number is selected from an individual symptom score scale representative of the clinical status of the chronic rhinosinusitis symptom being assessed. In another embodiment, the individual symptom score scale comprises a four point scale that is divided in increments of 1.

In still another embodiment, the individual symptom score scale further comprises a numerical value corresponding to the severity of the symptom. For example, 0 being no indication of the symptom (none), 1 being mild indication of the symptom (mild), 2 being moderate indication of the symptom (moderate), and 3 being severe indication of the symptom (severe).

In certain aspects of the present invention, the selection of two or more individual symptoms for use in calculating a composite score is based upon the validation of each of the two or more individual symptoms' relevance to the clinical severity of chronic rhinosinusitis in the one or more patients.

In certain embodiments, validation is determined by statistical analysis of the patent-reported information collected during the treatment regimen. In one embodiment, two individual symptoms can be selected for use in calculating the composite score. In another embodiment, three individual symptoms can be selected for use in calculating the composite score. In still another embodiment, four individual symptoms can be selected for use in calculating the composite score. In yet another embodiment, five individual symptoms can be selected for use in calculating the composite score. In still yet another embodiment, six individual symptoms can be selected for use in calculating the composite score.

In other certain embodiments, the calculation of a composite score is achieved by adding together the individual symptom scores of two or more individual symptoms determined selected in step (c) to obtain a sum value which reflects the clinical status of chronic rhinosinusitis.

In still other embodiments, the composite sum values can be compared by calculating the p value of the change in composite scores patient population as compared to the change in composite scores a patient population given a placebo or an alternate therapy. In such an embodiment, a treatment regimen can be identified as highly effective, effective, moderately effective, or not effective.

In another aspect of the present invention, the methods further comprise building a predictive model to determine a patient's healthcare outcome to a particular treatment regimen. In still another aspect of the present invention, the methods further comprise building a predictive model to determine a patient population's healthcare outcome to a particular treatment regimen. In yet another aspect of the present invention, the methods can be used to determine the efficacy of a new or untested treatment regimen for a patient population and further to compare it to existing treatment options.

A further objective of the invention can be to improve chronic rhinosinusitis treatment and determine the best method of treatment for a particular patient or patient population.

An advantage of the invention can be a scoring system that provides for the assessment of the level of chronic rhinosinusitis severity to enable improved and more accurate treatment of chronic rhinosinusitis sufferers. Furthermore, the score can be collected repeatedly and compared to previous scores to provide an indication as to the effectiveness of the chosen therapy in combating the patient's chronic rhinosinusitis.

Another advantage of the invention can be the ease in which patients are able to understand the system and provide accurate scores to users of the scoring system.

Another advantage of the invention can be the ease of calculating both individual and composite scores without the aid of a computer or calculator.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

Given the following enabling description of the drawings, the methods described herein should become evident to a person having ordinary skill in the art.

FIG. 1 is an example of a Chronic Sinusitis Symptom Diary (CSSD) questionnaire;

FIG. 2 is a second example of a CSSD questionnaire;

FIG. 3 provides one embodiment of a conceptual model of the symptoms to include in the CSSD score;

FIG. 4 provides a second embodiment of a conceptual model of the symptoms to include in the CSSD; and

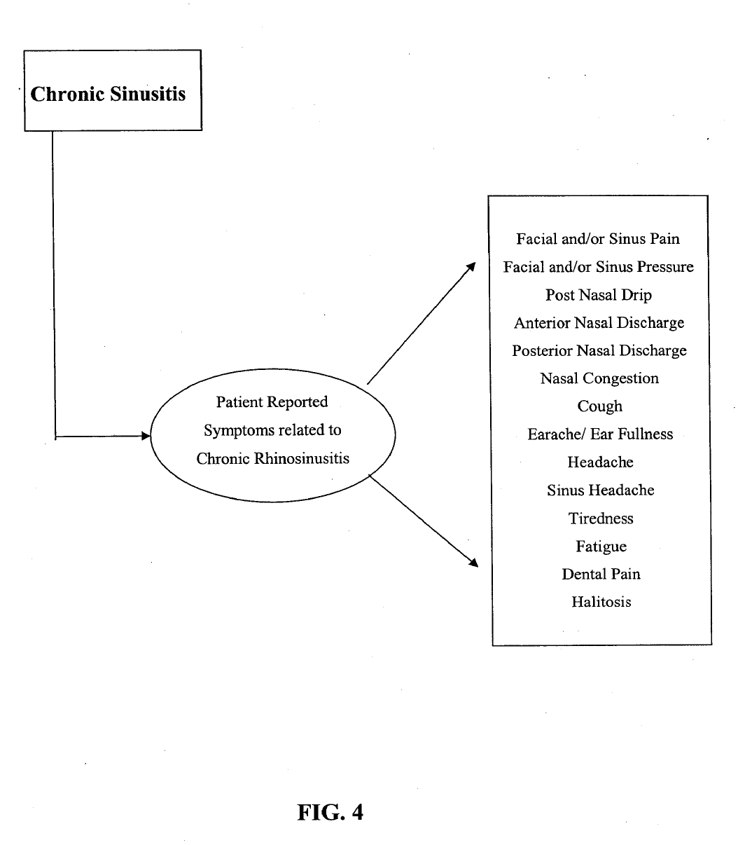

FIG. 5 is a graph illustrating the mean TSSS scores for a patient population taken over a 35 day period of time. The diamond (-♦-) represents the placebo group. The square (-▪-) represents the group administered 45 mg/3 mls SPRC-AB01 B.I.D. The triangle (-▴-) represents the group administered 90 mg/3 mls SPRC-AB01 B.I.D.

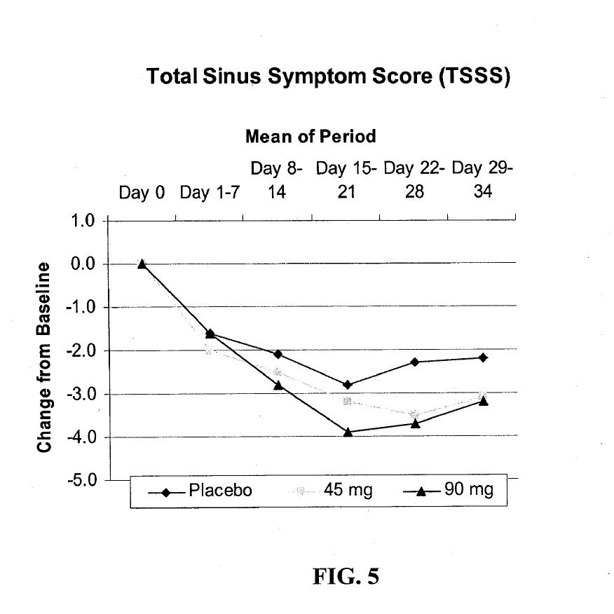

### DETAILED DESCRIPTION OF THE INVENTION

The novel features of the invention are set forth with particularity in the appended claims. A better understanding of the features and advantages of the present invention will be obtained by reference to the following detailed description. This invention can, however, be embodied in many different forms and should not be construed as limited to the embodiments set forth herein; rather, these embodiments are provided so that this disclosure will be thorough and complete, and will fully convey the scope of the invention to those skilled in the art.

Certain Definitions

As used herein, the terms “comprising,” “including,” and “such as” are used in their open, non-limiting sense.

The term “about” is used synonymously with the term “approximately.” As one of ordinary skill in the art would understand, the exact boundary of “about” will depend on the specific data analysis being conducted. Illustratively, the use of the term “about” indicates that values slightly outside the cited values, i.e., plus or minus 0.1% to 10%, are accurate and valid.

“Chronic rhinosinusitis” and “chronic sinusitis,” as used herein, are synonymous and refer to clinical disorders comprising an inflammatory disease of the nasal cavities, fluids within these cavities, the paranasal sinuses, and/or the underlying bone lasting at least 8 consecutive weeks (or greater than about 60 days) despite therapy.

“Chronic Sinusitis Symptom Diary (CSSD),” as used herein, refers to a daily assessment tool completed by a patient undergoing a chronic rhinosinusitis treatment regimen comprising a list of a plurality of clinical signs or symptoms related to chronic sinusitis and a severity scoring scale with which to assess the severity of each of the clinical signs or symptoms on a daily basis. In some embodiments, the plurality of clinical signs or symptoms related to chronic rhinosinusitis comprises at least one of facial or sinus pressure, facial or sinus pain, nasal congestion, anterior nasal discharge, posterior nasal discharge/post nasal drip, headache, sinus headache, cough, earache or ear fullness, dental pain, halitosis, tiredness/fatigue, or any combination thereof. In other embodiments, the plurality of clinical signs or symptoms related to chronic rhinosinusitis comprises at least one of facial or sinus pressure, facial or sinus pain, nasal congestion, post-nasal drip, sinus headache and tiredness/fatigue. In still other embodiments, the plurality of symptoms related to chronic rhinosinusitis comprises at least one of facial or sinus pressure, facial or sinus pain, anterior nasal discharge, posterior nasal discharge/post nasal drip, nasal congestion, sinus headache, and tiredness/fatigue. In yet other embodiments, the plurality of symptoms related to chronic rhinosinusitis comprises at least one of facial or sinus pain, cough, earache or ear fullness, nasal congestion, and dental pain.

In other embodiments, the severity scoring scale is based upon a 4-point symptom severity scale ranging from 0 (None) to 3 (Severe). In some embodiments, the CSSDs can be kept from study Day 1 until the end of study (EOS). In other embodiments, the daily diaries can be kept from the start of a placebo run-in period, through the study treatment period and through the defined study follow-up period until the end of study.

“Facial or Sinus Pressure,” as used herein, is defined as pressure or fullness in the area behind the eyes, cheeks, forehead, or sinuses.

“Facial or Sinus Pain,” as used herein, is defined as pain in the area behind the eyes, cheeks, forehead, or sinuses.

“Nasal Congestion,” as used herein, is defined as the patient having a stopped up or stuffy nose.

“Posterior nasal discharge” and “Post-Nasal Drip,” as used herein are synonymous and are defined as sinus drainage in the back of the throat.

“Sinus Headache,” as used herein, is defined as dull to intense, throbbing pain in the head.

“Tiredness” and “fatigue,” as used herein are synonymous and are defined as feeling worn out or drained due to chronic sinusitis.

“Subject-Rated Total Sinus Symptom Score (TSSS)” or “Total Sinus Symptom Score (TSSS),” as used herein, refers to the sum of selected signs and symptoms recorded by the subject or patient on the questionnaire related to a plurality of symptoms related to chronic rhinosinusitis provided in the CSSD. In certain embodiments, the TSSS is calculated based upon the patient ratings of selected symptom severity scores entered into daily diaries (CSSDs). In some embodiments, the Subject-Rated TSSS can provide a descriptive analysis of the time course of response to a specific treatment regimen based upon the change in the baseline Subject-Rated TSSS value as compared to the patient's Daily Subject-Rated TSSS values calculated during the course of a treatment regimen. In other embodiments, the Subject-Rated TSSS can provide a descriptive analysis of the time course response to a specific treatment regimen based upon the change in the baseline Subject-Rated TSSS value as compared to the patient's average weekly Subject-Rated TSSS values calculated during the course of the treatment regimen.

In certain embodiments, the TSSS can be defined as a scoring tool comprising the composite score of at least two or more individual signs and symptoms of chronic rhinosinusitis, as reported by subjects, selected from the plurality of clinical signs or symptoms related to chronic rhinosinusitis provided in the CSSD. For example, the plurality of clinical signs or symptoms related to chronic rhinosinusitis provided in the CSSD can include facial or sinus pressure, facial or sinus pain, nasal congestion, anterior nasal discharge, posterior nasal discharge/post nasal drip, headache, sinus headache, cough, earache or ear fullness, dental pain, halitosis, tiredness/fatigue, or any combination thereof. In certain embodiments, the TSSS comprises the composite score of at least two signs and symptoms of chronic rhinosinusitis selected from the plurality of clinical signs or symptoms related to chronic rhinosinusitis provided in the CSSD. In other embodiments, the TSSS comprises the composite score of at least three signs and symptoms of chronic rhinosinusitis selected from the plurality of clinical signs or symptoms related to chronic rhinosinusitis provided in the CSSD. In still other embodiments, the TSSS comprises the composite score of at least four signs and symptoms of chronic rhinosinusitis selected from the plurality of clinical signs or symptoms related to chronic rhinosinusitis provided in the CSSD. In yet other embodiments, the TSSS comprises the composite score of at least five signs and symptoms of chronic rhinosinusitis selected from the plurality of clinical signs or symptoms related to chronic rhinosinusitis provided in the CSSD. In yet still other certain embodiments, the TSSS comprises the composite score of at least six signs and symptoms of chronic rhinosinusitis selected from the plurality of clinical signs or symptoms related to chronic rhinosinusitis provided in the CSSD. In other embodiments, the TSSS comprises the composite score of at least seven signs and symptoms of chronic rhinosinusitis selected from the plurality of clinical signs or symptoms related to chronic rhinosinusitis provided in the CSSD. In still other embodiments, the TSSS comprises the composite score of at least eight signs and symptoms of chronic rhinosinusitis selected from the plurality of clinical signs or symptoms related to chronic rhinosinusitis provided in the CSSD. In yet other embodiments, the TSSS comprises the composite score of at least nine signs and symptoms of chronic rhinosinusitis selected from the plurality of clinical signs or symptoms related to chronic rhinosinusitis provided in the CSSD. In still other embodiments, the TSSS comprises the composite score of at least ten signs and symptoms of chronic rhinosinusitis selected from the plurality of clinical signs or symptoms related to chronic rhinosinusitis provided in the CSSD. In yet still other certain embodiments, the TSSS comprises the composite score of at least eleven or more signs and symptoms of chronic rhinosinusitis selected from the plurality of clinical signs or symptoms related to chronic rhinosinusitis provided in the CSSD.

“Physician TSSS,” as used herein, refers to the scores given on the questionnaire completed by the physician related to the plurality of symptoms related to chronic rhinosinusitis upon examination of a patient. In one embodiment, the physician TSSS is based upon the patient's history as taken by the examining physician, as well as information obtained by a physical examination of the patient or subject.

“Patient-Rated Global Assessment,” as used herein, refers to a five point rating by the subject or patient indicating the degree to which symptoms improved during a particular treatment. In some embodiments, the patient-rated global assessment can range from 1 (complete relief, NO signs/symptoms present) to 5 (worsening, NO relief, signs/symptoms worse). In other embodiments, 1=Complete Relief (NO signs/symptoms present), 2=Marked Relief (signs/symptoms Greatly Improved), 3=Moderate Relief (signs/symptoms are Present but are Noticeably Improved), 4=Slight Relief (signs/symptoms are Present with Minimal Improvement), and 5=No Relief (signs/symptoms Unchanged or Worse). In other embodiments, the patient-rated global assessment can be a rating scale other than 5. In one such embodiment, a six point rating scale can be used by the patient.

“Patient-Rated Global Impression of Change (PGI-C),” as used herein refers to a eight point rating by the subject or patient indicating the change in status of the patient's sinus condition at the time the PGI-C is completed. In certain embodiments, the PGI-C can range from 0 (Don't know) to 7 (Very much worse). In other embodiments, 0=Don't know, 1=Very much better, 2=Much better, 3=A little better, 4=About the same, 5=A little worse, 6=Much worse, and 7=Very much worse. In other embodiments, the PGI-C can be a rating scale other than eight, e.g. a seven point rating scale.

“Patient-Rated Global Impression of Severity (PGI-S),” as used herein refers to a seven point rating by the subject or patient indicating the severity of the patient's sinus condition at the time the PGI-S is completed. In certain embodiments, the PGI-S can range from 1 (normal) to 7 (very severely ill). In other embodiments, 1=normal, 2=borderline, 3=mildly ill, 4=moderately ill, 5=markedly ill, 6=severely ill, and 7=very severely ill. In other embodiments, the PGI-S can be a rating scale other than seven, e.g. a five point rating scale.

“Physician-Rated Global Assessment,” as used herein, refers to a five point rating by the investigator indicating the degree to which symptoms improved during a particular treatment. In some embodiments, the physician-rated global assessment can range from 1 (complete relief, NO signs/symptoms present) to 5 (worsening, NO relief, signs/symptoms worse). In other embodiments, the physician can further inquire as to the need of the patient for additional antimicrobial therapy. In some embodiments, the physician-rated global assessment can be a rating scale other than 5. In one such embodiment, a six point rating scale can be used.

“Physician-Rated Clinician Global Impression of Change (CGI-C),” as used herein refers to a eight point rating by a physician regarding the change in status of the patient's sinus condition at the time the CGI-C is completed. In certain embodiments, the CGI-C can range from 0 (Not assessed) to 7 (Very much worse). In other embodiments, 0=Not assessed, 1=Very much improved, 2=Much improved, 3=Minimally improved, 4=No change, 5=Minimally worse, 6=Much worse, and 7=Very much worse. In other embodiments, the CGI-C can be a rating scale other than eight, e.g. a seven point rating scale.

“Physician-Rated Clinician Global Impression of Severity (CGI-S),” as used herein refers to a seven point rating by a physician indicating the severity of the patient's sinus condition at the time the CGI-S is completed. In certain embodiments, the CGI-S can range from 1 (normal) to 7 (very severely ill). In other embodiments, 1=normal, 2=borderline, 3=mildly ill, 4=moderately ill, 5=markedly ill, 6=severely ill, and 7=very severely ill. In other embodiments, the CGI-S can be a rating scale other than seven, e.g. a five point rating scale.

“Treatment regimen,” as used herein refers any therapeutic course of action for a specific disease or disorder and can comprise the following stages: (a) patient assessment (including patient screening and patient run-in periods); (b) treatment (including administration of either a therapeutic agent or a placebo); and (c) patient follow-up.

The Chronic Sinusitis Symptom Diary (CSSD)

In some embodiments of the invention described herein, a patient can be provided with or otherwise given access to a Chronic Sinusitis Symptom Diary (CSSD) questionnaire in one of several different modalities. In one embodiment, the CSSD can be completed by a patient while the patient is undergoing a chronic rhinosinusitis treatment regimen. In another embodiment, the CSSD can be completed by a patient while the patient is undergoing a chronic rhinosinusitis treatment regimen such that the patient's clinical status of chronic rhinosinusitis is being assessed over the duration of the treatment regimen. In yet another embodiment, the CSSD can be completed during a predetermined period of time while the patient is being evaluated for the determination of the severity of the patient's symptoms related to chronic rhinosinusitis.

In certain embodiments, the CSSD is completed every day throughout the duration of a treatment regimen. In other embodiments, the CSSD is completed every day throughout the predetermined period of time while the patient is being evaluated for the determination of the severity of patient's symptoms related to chronic rhinosinusitis. In still other embodiments, the CSSD is to be completed daily but only in the evening. In yet still other embodiments, the CSSD is completed daily but not within up to four hours after taking any pain medications not specifically recited in the treatment regimen being evaluated.

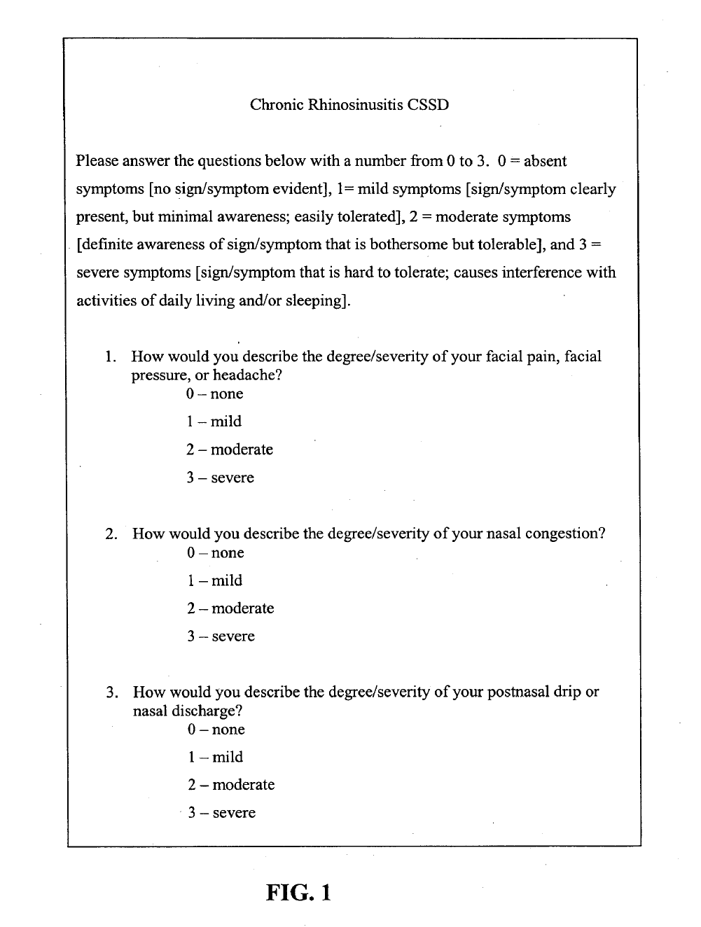

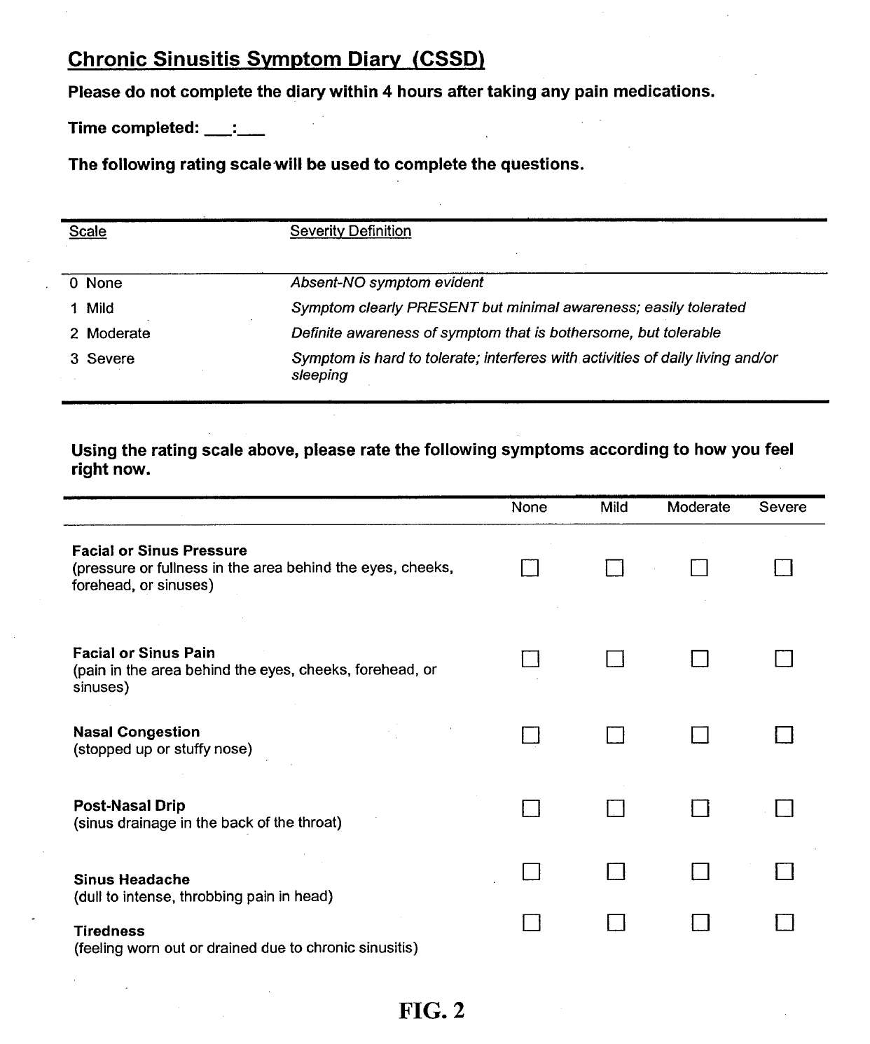

In certain embodiments, the patient receives a questionnaire in a paper or written format in which the survey can be given to the patient as questions, for example, as in FIGS. 1 or 2. Alternatively, interviewing a patient can comprise a situation in which a user, such as a healthcare worker or physician, asks the patient questions in person. In another embodiment, the patient can be interviewed by a live telephone conversation or a recorded telephone survey (e.g. an Interactive Voice Response System). In another embodiment, the patient can be sent the questionnaire via a fax machine. In another embodiment, the patient can access the questionnaire via an Electronic Data Capture system, such as a website that can be accessed through a remote computer in which the patient's answers are submitted and communicated to the user through the internet. In yet another embodiment, the patient can access the questionnaire through an Electronic Data Capture system via a computer, for example at a healthcare facility, and directly input their responses to the questions contained in the questionnaire into a computer databases stored thereon.

In some embodiments, the patient can be asked to provide answers to questions directed to a plurality of symptoms related to chronic rhinosinusitis. The plurality of symptoms related to chronic rhinosinusitis can comprise at least one of facial or sinus pressure, facial or sinus pain, nasal congestion, anterior nasal discharge, posterior nasal discharge/post nasal drip, headache, sinus headache, cough, earache or ear fullness, dental pain, halitosis, tiredness/fatigue, or any combination thereof In one embodiment, the plurality of symptoms related to chronic rhinosinusitis comprises at least one of facial or sinus pressure, facial or sinus pain, nasal congestion, posterior nasal discharge/postnasal drip, sinus headache, and tiredness/fatigue. In another embodiment, the plurality of symptoms related to chronic rhinosinusitis comprises at least one of facial or sinus pressure, facial or sinus pain, anterior nasal discharge, posterior nasal discharge/post nasal drip, nasal congestion, sinus headache, and tiredness/fatigue. In yet another embodiment, the plurality of symptoms related to chronic rhinosinusitis comprises at least one of facial or sinus pain, cough, earache or ear fullness, nasal congestion, and dental pain.

In certain embodiments, the CSSD can comprise the following (or similar) questions, as illustrated in FIG. 1:

1) How would you [your patient] describe the severity of your facial pain?

2) How would you [your patient] describe the severity of your nasal congestion?

3) How would you [your patient] describe the severity of your postnasal drip?

The bracketed text preferably replaces the preceding word when the user is a healthcare provider, and thus is not included in the questions posed directly to patients.

In other embodiments, the CSSD can comprise the following (or similar) questions, as illustrated in FIG. 2 and in the following paragraphs:

A patient is asked to assign an individual symptom score for each symptom based on their subjective self-assessment of the symptom represented by a number. The patient will be asked to use the following individual score scale comprising a four point rating scale that is divided in increments of 1: (Scale Score=0)—no indication of the symptom is evident to the patient, (Scale Score=l)—a mild indication of the symptom in which the symptom is present but the patient has minimal awareness of it and the symptom is easily tolerated, (Scale Score=2)—a moderate indication of the symptom and the patient has a definite awareness of the symptom that is bothersome but tolerable, or (Scale Score=3)—a severe indication of the symptom and the symptom is hard to tolerate because it interferes with the patient's activities of daily living and/or sleeping.

In one embodiment, the patient is instructed to use the four point rating scale (0 to 3) to rate the following symptoms according to how the patient feels at the time of the self-assessment: (1) Facial or Sinus Pressure; (2) Facial or Sinus Pain; (3) Nasal Congestion; (4) Posterior nasal discharge/Post-Nasal Drip; (5) Sinus Headache; and (6) Tiredness/Fatigue.

In still other embodiments, the user, such as a healthcare worker or physician, will assign the individual symptom score based information collected during an interview, e.g., the patient's subjective response to the questions and its corresponding description on the individual score scale.

In certain embodiments of the present invention, the patient-reported information for each of the individual symptoms collected using the CSSD over the course of a treatment regimen (or a predetermined period of time while the patient is being evaluated for a determination of the severity of the patient's symptoms related to chronic rhinosinusitis) is statistically analyzed to determine each individual symptom's clinical relevance in evaluating chronic rhinosinusitis in a patient population. Once the statistical analysis is complete and clinical relevance is determined for each of the individual symptoms, two or more of the individual symptoms provided in the CSSD will be selected for use in a TSSS composite score. In certain embodiments, the TSSS can be used to determine the efficacy of a treatment regimen for treating chronic rhinosinusitis. In other embodiments, the TSSS can be used to assess of chronic rhinosinusitis in a patient or patient population. In still another embodiment, the TSSS can be used in determining the severity of the patient's symptoms related to chronic rhinosinusitis in a patient.

Selection of Individual Symptoms of use in Total Sinus Symptom Score (TSSS)

The selection of individual symptoms recited in the CSSD for use in the TSSS composite score is based upon the blinded statistical analysis of each of the individual symptoms in the CSSD to determine each individual symptom's validity in determining the clinical status of chronic rhinosinusitis. As used herein, all statistical analyses are conducted using SAS version 9 (or higher) for Windows®. The statistical analyses are primarily directed to psychometric validation, e.g., the magnitude of relationships between variables and the pattern of their overall results. However, where specific significance tests are used, the threshold for statistical significance will be p<0.05 for each test. In addition, correlations between composite scores (TSSS) or other continuous data (CSSD) is calculated using Pearson's correlation. Correlations between ordinal symptoms scores (Scale Scores) or other ordinal data is calculated using Spearman's correlation.

Based upon the results of the statistical analyses, the individual symptoms recited in the CSSD can either be included or excluded for use in calculating the TSSS composite score.

In certain embodiments, each individual symptom can be statistically analyzed to determine if the data related to a specific individual symptom is markedly less likely to be provided by a patient than the data related to another specific individual symptom. In such an embodiment, individual symptoms with markedly more missing data than other individual symptoms in the CSSD are scrutinized and considered for deletion. In one such embodiment, individual symptoms missing patient-reported responses for more than about 10 percent of the patients surveyed are considered for exclusion in the TSSS composite score. In another embodiment, individual symptoms missing patient-reported responses for more than about 15 percent of the patients surveyed are considered for exclusion in the TSSS composite score. In yet another embodiment, individual symptoms missing patient-reported responses for more than about 20 percent of the patients surveyed are considered for exclusion in the TSSS composite score. In still yet another embodiment, individual symptoms missing patient-reported responses for more than about 25 percent of the patients surveyed are considered for exclusion in the TSSS composite score.

In certain other embodiments, the distribution qualities the responses related to each individual symptom can be statistically analyzed to determine whether to include or exclude the individual symptom in the TSSS composite score. For example, individual symptoms with overly skewed response distributions and/or unused response categories (i.e., scale scores) may not be clinically relevant to the status of chronic rhinosinusitis is a patient and may be considered for exclusion from the TSSS composite score.

In yet other embodiments, inter-item correlation can be examined. For example, individual symptoms which have an extremely high correlation with each other (>0.80) are scrutinized and considered for deletion. Such individual symptoms may be so similar in content to one or more other individual symptoms that the individual symptom(s) may be considered for exclusion from the TSSS composite score.

In still other embodiments, item-level responsiveness can be examined. In certain aspects, the primary test for responsiveness of the individual symptoms are conducted using end-of-study data, a weekly averages (e.g., days 22-28 of a 50 day study), and the Subject-Rated GIC at the end-of-study visit. In certain embodiments, the change from baseline values are calculated from the Subject-Rated symptom weekly averages.

In one such embodiment, two groups of patients (improved vs. unimproved) are created based on the change from baseline (Day 1 of the study) in the Subject GIC at Day 29. The patients who show at least one category of improvement from Day 1 are considered the “improved” group, while patients rated in the remaining categories (no change or deterioration in one or more categories) are considered the “unimproved” group. The between-group standardized effect size (SES) is calculated as the difference between the improved group mean and the unimproved group mean divided by the pooled standard deviation. Based upon statistical methods known in the art, a between-group SES of 0.8 or greater is considered high, a between-group SES of 0.5 is moderate, and a between-group SES of 0.2 is small. Accordingly, individual symptoms that do not show at least a SES of greater than or equal to 0.2 in the blinded assessment of responsiveness are considered for exclusion from the TSSS composite score.

In yet other embodiments, concurrent validity can be examined. In such embodiments, the Subject-Rated entries from the TSSS and the individual symptom ratings averages over a fixed period of time (e.g., days 15-21, and days 22-28) can be correlated with the Physician-Rated TSSS and individual symptom ratings at a certain time point (e.g., day 22 and day 29). While the Subject-Rated endpoint is a one week average and the Physician-Rated data is measured on a single time point, the correlations are expected to be moderate (r>0.40). In certain embodiments, these correlations can be repeated for end-of-study data.

In still other embodiments, Exploratory Factor Analysis (EFA) can be used to determine the dimensionality of the CSSD, with a primary focus on whether there exists a set of symptoms for which it is sensible to compute a summated score. In certain embodiments, it is hypothesized that certain symptoms of chronic rhinosinusitis may form a single factor, or that certain symptoms may form a separate factor or may have little cohesiveness. Due to the fact that in certain embodiments, the patients undergoing evaluation may be required to have a minimum summed symptom score of at least 5 on the CSSD at screening and at the start of placebo run-in, end-of-study data can be used for the EFA to assure adequate item variance for the analytic procedures. In certain embodiments, EFA analyses can be conducted on both day level item data and weekly average item data.

Collection of Data

The individual symptom scores and/or the composite symptom score from a patient can be manually written in the patient's daily diary, the patient's medical records, submitted via a telephone survey (e.g. Interactive Voice Response System), submitted via an on-line questionnaire accessed over the Internet, submitted via a facsimile, and/or entered into a computer database (e.g. Electronic Data Collection Systems).

As will be appreciated by one of skill in the art, the present invention can be embodied as a method, data processing system, or computer program product. Accordingly, the present invention can take the form of an entirely hardware embodiment, an entirely software embodiment or an embodiment combining software and hardware aspects. Furthermore, the present invention can take the form of a computer program product on a computer-usable storage medium having computer-usable program code means embodied in the medium. Any suitable computer-readable medium can be utilized including hard disks, CD-ROMs, optical storage devices, or magnetic storage devices. Other alternative embodiments can include the creation of a database of the scores such that as data is entered for the total sinus symptom score a record is developed corresponding preferably either to the name or social security number, which may be replaced by another type of identification assignment such as a number, letter, symbol, or combination thereof. This alternative embodiment will allow for later analysis of the total sinus symptom scores from a patient population. This alternative embodiment will also allow for tracking of how effective therapies are for treating chronic rhinosinusitis. A further alternative can be that identifying information can be selectively not saved to protect the privacy of the patient. Another alternative can be for the information to be associated with biometric information for the individual or other type of identifying method.

Determining the Efficacy of a Treatment Regimen for Chronic Rhinosinusitis

In certain embodiments of the present invention, the efficacy of a treatment regimen for chronic rhinosinusitis can be determined using the systems and methods described herein. In such embodiments, a placebo run-in period for statistical purposes can first be performed in which the patient or patient population receives a placebo treatment for several days prior to the initiation of treatment. During the placebo run-in period the patient or patient population is to complete the CSSD on a daily basis. In some embodiments, the run-in period can be from one to thirty days. In other embodiments, the run-in period can be from one to fourteen days. In still other embodiments, the run-in period can be from five to ten days. In yet other embodiments, the run-in period can be seven days. The patient population can then be randomized.

In one embodiment, a TSSS score can be calculated after the placebo run-in period to serve as a baseline level. In such an embodiment, the baseline level TSSS value can be defined as the average of non-missing CSSD values for the individual symptoms selected using the methods set forth above occurring during the placebo run-in period. For example, baseline level TSSS value can be defined as the average of non-missing CSSD values for the individual symptoms selected using the methods set forth above occurring from day-6 and ending on day 0.

In another embodiment, subsequent TSSS composite scores are calculated over the course of the treatment regimen. In some embodiments, the TSSS composite scores calculated post-initiation of therapy can be compared to either the baseline score and/or previously calculated TSSS composite scores. Such a comparison can be used to determine the efficacy of the treatment by statistical analysis. In some embodiments, the efficacy of a treatment regiment is categorized based on the statistical results of the individual patient's TSSS composite scores calculated during a study. In one embodiment, the efficacy of a treatment regimen can be categorized as highly effective, effective, moderately effective, or not effective.

In some embodiments, the methods described for determining the efficacy of a treatment regimen can further comprise building a predictive model to determine a patient or patient population's healthcare outcome as related to a particular treatment regimen. In one such embodiment, a predictive model for a particular treatment regimen is forecast by using statistical data related to the use of a particular treatment in a particular patient group, e.g., moderate CRS. Such an analysis can provide insight into the possible outcome of a treatment for use in a patient categorized in a particular patient group.

Assessment of the Response to a Particular Treatment Regimen in a Patient or Patient Population

In other embodiments of the present invention, the assessment of a particular treatment regimen in a patient or patient population can be made using the systems and methods described herein. In such embodiments, a placebo run-in period for statistical purposes can first be performed in which the patient or patient population receives a placebo treatment for several days prior to the initiation of particular treatment. During the placebo run-in period the patient or patient population is to complete the CSSD on a daily basis. In some embodiments, the run-in period can be from one to thirty days. In other embodiments, the run-in period can be from one to fourteen days. In other embodiments, the run-in period can be from five to ten days. In yet other embodiments, the run-in period can be seven days. Upon completion of the run-in period, an individual TSSS composite score can be collected from the patient to serve as a baseline score. In such an embodiment, the baseline level TSSS value can be defined as the average of non-missing TSSS values for the individual symptoms selected using the methods set forth above occurring during the placebo run-in period starting at day-6 and ending on day 0. Once the baseline TSSS composite score has been calculated, the patient can then be started on a particular treatment regimen.

In some embodiments, the patients assess their individual symptoms daily in a diary (CSSD). The patients' CSSD values for the individual symptoms can be statistically evaluated by the methods described herein to determine which of the individual symptoms are to be included in determining the TSSS composite score. Upon making this determination, the mean weekly averages of the TSSS composite scores are statistically compared to determine a change from baseline TSSS score. In another embodiment, TSSS composite score can be then collected from the patient at a later point in time, e.g., three weeks post initiation of therapy. The TSSS composite score can be then compared to the baseline TSSS score. In some embodiments, the TSSS composite score can be calculated at a later time point and compared to either the baseline TSSS score and/or previously calculated TSSS composite scores to determine changes. In some embodiments, the comparison of TSSS composite scores calculated after initiation of therapy with the baseline score or an earlier calculated TSSS composite score can provide a means for assessing the response of a patient to a particular treatment regimen. In other embodiments, the composite score (TSSS) can be compared to known diagnostic criteria for use in additional statistical analysis to assess a response to a particular treatment regimen. In still other embodiments, the composite score (TSSS) can be compared to known diagnostic criteria such as a look up table, e.g., a medical reference text or database.

Determining the Severity of a Patients' Symptoms related to Chronic Rhinosinusitis

In some embodiments of the invention, the determination of the severity of symptoms related to chronic sinusitis in a patient can be made using the systems and methods described herein. In certain embodiments, the composite score (TSSS) can be compared to known diagnostic criteria and can be used by a physician or healthcare worker to diagnose a patient with chronic rhinosinusitis. In one embodiment, the known diagnostic criteria can have a threshold score in which determining the severity of symptoms related to chronic rhinosinusitis is definitive. In an alternative embodiment, the known diagnostic criteria can have a threshold score and a standard of error such that the composite score can prove to be relevant even if it is not above the threshold score but it is within the standard of error. In yet another embodiment, the known diagnostic criteria can be in the form of threshold scores that are listed in a lookup table, e.g., a medical reference text or database. In still another embodiment, the known diagnostic criteria can have multiple threshold scores corresponding to the severity of disease progression which, when compared to a patient's composite score, determines the severity of symptoms related to chronic rhinosinusitis that is, e.g., mild, moderate, or severe chronic rhinosinusitis.

Statistical Analysis of the TSSS

The systems and methods described herein can further comprise the unblinded statistical analysis of the composite scores (TSSS) by known statistical methods, e.g., the analysis of variance (ANOVA) or the analysis of covariance (ANCOVA). In some embodiments, the statistical analyses are conducted using computer software. In one embodiment, the statistical analyses are conducted using SAS version 9 (or higher) for Windows®.

In one aspect of the invention, a domain-based approach can be used to test construct validity by determining whether the hypothesized domain structure can be validated using factor analytic methods. In one embodiment, a three item scale hypothesized as unidimentional to support the validity of a summated composite score, principal components analysis (PCA) can be performed as an aid in determining if the hypothesized grouping of items into one composite score is appropriate. In one such embodiment, end of study (EOS) data can be used for the PCA analysis to ensure adequate item variance for proper analytic procedures. In such an embodiment, PCA analysis of patient's subjective TSSS scores can be conducted on both day level item data, e.g., the last day of the study, and weekly average item data, e.g., the last full week of the study. In another such embodiment, TSSS scores determined by a healthcare provider can be analyzed using PCA.

In another aspect of the invention, the score distribution and floor/ceiling effects (the percentages of subjects with the lowest and highest possible scores on each scale) can be analyzed. In determining floor and ceiling effects, it is necessary to interpret the effects in relation to the severity of the population which is included in the study sample. In one such embodiment, the symptom and TSSS distributional characteristics including mean scores and symptom response distributions at baseline are reported. In some embodiments, the domain distributional characteristics for the samples can be restricted due to the inclusion criteria set forth in each study. Such exclusion will assure that floor effect did not interfere with the ability of the domain to detect improvement due to treatment.

In another aspect of the invention, the internal consistency reliability can be calculated for the Subject TSSS completed at the end of the study using Cronbach's α. Cronbach's α is expected to be 0.70 or greater for internally consistent multi-item domains intended for use in the making of group-level comparisons. See Nunnally et al., Psychometric Theory, 3rd Ed., McGraw-Hill, Inc. (1994). In certain embodiments, the test-retest reliability can be reviewed using an assessment that established a stable group compared to those who have changed in one direction or the other over a relatively short recall period during which few potential confounds are introduces. In preferred embodiments, maximum variability in subject scores is desired for assessing test-retest reliability, as restriction of the range may attenuate correlation and intraclass correlation coefficient (ICC). In one embodiment, the test-retest reliability can be computed for the TSSS using a Pearson's correlation between the TSSS calculated averages for days 22-28 and 29-35 using only the subjects who stay in the trial to completion. The selection of these two periods should maximize the range of available TSSSs, as well as provide two periods close in time during which few, if any, confounds are introduced. In such an embodiment, the test-retest reliability score can be evaluated using 0.70 or greater as the threshold value for reliability. In another embodiment, between day test-retest reliability can be evaluated for the Subject-Rated TSSS using Day 14 and Day 15 data for all patients in the study. Test-retest reliability can also be calculated between the TSSS22-28 and TSSS29-35. In addition, test-retest can be calculated between the TSSS-6-0 and TSSS22-28. In yet another embodiment, the Physician TSSS test-retest reliability can be calculated using the Pearson's correlation between Day 22 and Day 35.

In another aspect of the present invention, concurrent validity can be determined. For example, the TSSS scores from the CSSD and the individual symptom ratings can be averaged over Days 15-21 and Days 22-28 and correlated with Physician-Rated TSSS and individual symptom ratings at Day 22. In some embodiments, the correlations can be expected to be moderate (r>0.40), with the strongest correlation seen for the TSSS correlations. In other embodiments, the correlations can be repeated for the data collected at the completion of the study.

In yet another aspect of the invention, clinical validity can be evaluated. In one such embodiment, the Subject-Rated TSSS end of study averages calculated from the CSSD, and the end of study Physician-Rated TSSS can be evaluated. In certain embodiments, multiple variables can be used to define the groups for analysis. In one embodiment, the variables can be selected from: (1) Physician-Rated Clinician Global Impression of Change (CGI-C) at the end of study; (2) Physician-Rated Global Assessment at the end of study visit; (3) Physician assessment of need for addition antibiotics (yes/no) at the end of study visit; (4) Endoscopy Results at specific time points (e.g. Day 29 and Day 49 of study); (5) nasal microbiology results; (6) nasal cytology results; and (7) peripheral eosinophil counts. In another embodiment, the variables are (1) Physician-Rated Clinician Global Impression of Change (CGI-C) at the end of study and (2) Endoscopy Results at specific time points (e.g. Day 29 and Day 49 of study). In another embodiment, absolute, as well as, change from baseline TSSS scores can be compared between the defined groups.

In still another aspect of the invention, continuous measure can be determined. In certain embodiments, the Pearson's correlations can be calculated between the change in baseline TSSS endpoints and the following endpoints: (1) Change from Day 1-eosinophils and neutrophils obtained from endoscopic cultures at Day 29 and Day 49 of the study; and (2) Change from Screening in peripheral eosinophils at Day 36 and Day 49.

In still yet another aspect of the invention, a patient or patient population's responsiveness to change can be statistically analyzed. In certain embodiments, the primary test for responsiveness of the TSSS can be conducted using end-of-study data, specifically responsiveness can be measured using TSSS₂₂₋₂₈ and the Patient-Rated Global Impression of Change (PGI-C). In such an embodiment, two groups of patients (improved vs. unimproved) can be created based on the change from baseline (Day 1) in the PGI-C at Day 29. Patients that show at lease one category of improvement from Day 1 are considered to the “improved” group, while patients who show no change or change of one or more categories of deterioration are considered the “unimproved” group. In certain other embodiments, responsiveness can be determined using end of study data; weekly average from Days 28-35 and the Subject-Rated Global Impression of Change (PGI-C) at the end of the study. In still other embodiments, responsiveness can be determined using the (PGI-C) at Day 22 and weekly average from study Days 15-21 and Days 22-28. In yet another embodiment, the change from baseline can be calculated fro the Subject-Rated TSSS weekly averages.

Regardless of the group designation used to determine responsiveness to change, paired t-tests can be used to compare the mean change difference for each group (e.g., improved group vs. unimproved group) to 0. In yet another embodiment, student t-tests can also be used to test for differences between the two groups. In some embodiments, the threshold significance for these tests can be p<0.05, with no adjustments for multiple testing. For each group, the mean change for the TSSS can be converted to standardized effect size (SES) using known methods. The SES for the unimproved group should be a value near 0, while the SES for the improved group should preferably be as large as possible. In yet another embodiment, between-group SES can be calculated as the difference between the improved group mean value and the unimproved group mean value divided by the pooled standard deviation. In some embodiments, a between group SES size of 0.8 or greater is considered large, 0.5 is moderate, and 0.2 is small.

In still yet other embodiments, the Minimal Importance Difference (MID) is determined for the TSSS composite score. The MID a calculation of the minimum change in the TSSS score of a patient or patient population that would find the treatment regimen clinically relevant. The primary method used to create the MID is examining the patient-reported change in the patient reported severity. The statistical change from baseline to weekly averages (mean, median, and standard deviation) are reported and charted for each category improvement. By way of a non-limiting example, the PGI-S at Day 29 (along with descriptive statistics of the change from baseline to TSSS22-28 (mean, median, and standard deviation) are reported and plotted against the change from baseline in the PGI-S. The MID can be estimated to be the within-subjects change that is associated with one category of improvement.

The MID is to be evaluated through standard error of measurement (SEM), SES and a change of ½ standard deviation. The MID estimates resulting from SEM, SES, and ½ standard deviation of change can be presented and analyzed alongside the MID estimates from patient report change. In addition, SEM (standard deviation×√(1-reliability)), an estimate of MID that is based on the reliability of the questionnaire, can be equivalent to the ½ s.d. when reliability =0.75 and decreases as reliability increases. The logic behind the relationship is that as the noise inherent in the tool decreases, a score smaller than the ½ standard deviation estimate becomes more meaningful. Research using the SEM indicates a convergence between anchor based and distribution based methods. The internal consistency reliability has been proposed as the most stable estimate to use in calculation of the SEM. In some embodiments, the MID can be estimated for the Subject-Rated TSSS weekly average for study Days 15-21 and Days 22-28. The MID can be estimated to be within the patients change associated with “slight relief.” In one embodiment, a MID in the point range of about 0.80 to about 0.85, as calculated from baseline, can be appropriate for evaluation of clinical relevancy. In another embodiment, the per protocol MID from baseline can be about 2.0 for evaluation of clinical relevancy.

### EXAMPLES

### Example 1

The following systems and methods disclosed herein correspond to that described above. The methods below describe with particularity embodiments of methods of assessing a patient population's response to a treatment regiment for chronic rhinosinusitis. Any methods which are not particularly described will be generally known and available to those skilled in the art of statistical analysis of clinical data.

A Phase II clinical trial was conducted to assess the effectiveness of a particular treatment regimen for Chronic Rhinosinusitis. This study was conducted as a randomized, double-blind, placebo-controlled, multi-center clinical study to assess the effectiveness of the drug composition SPRC-AB01 on the treatment of Chronic Rhinosinusitis. Patients were screened for inclusion in the clinical trial based upon the following selection criteria:

1. History of Chronic Rhinosinusitis;

2. History of sinus surgery for Chronic Rhinosinusitis;

3. Signs/symptoms of Chronic Rhinosinusitis post surgery for at least 90 days;

4. Endoscopic evidence documenting pus from an open sinus with mucosal inflammation; and

5. No antibiotic treatment for the last 7 days prior to entry.

Based upon the above criteria, 58 patients were selected and enrolled into the study. The patients were divided into three patient groups: Group 1—Placebo (19 patients); Group 2—Low Dose—45 mg/3 ml SPRC-AB01 (19 Patients); and Group 3—High Dose—90 mg/3 ml SPRC-AB01 (20 Patients). All groups were well balanced by demographics and disease severity. Each group was administered the placebo or drug composition twice a day (B.I.D) for 21 days by a nasal inhalation nebulizer.

All patients were subject to a run-in period of between 1 to 7 days to establish a baseline value. Participating patients took the placebo or study medication for 21 days, with 14 additional days of follow-up. Patients kept a daily diary which included a TSSS questionnaire evaluating the severity of a plurality of symptoms related to chronic rhinosinusitis. Three clinical symptoms were measured by the subjective determination of the patient using the TSSS questionnaire: 1. Facial Pain and Facial Pressure; 2. Congestion; and 3. Post-Nasal drip. Each symptom was scored using the symptom severity four-point scale ranging from 0-3, with 0=None, 1=Mild, 2=Moderate, and 3=Severe. Daily assessments were conducted throughout the 35 day study. In addition to the daily diary, follow-up visits, along with physician assessments, were conducted at Day 22 and Day 35 of the study.

### Example 2

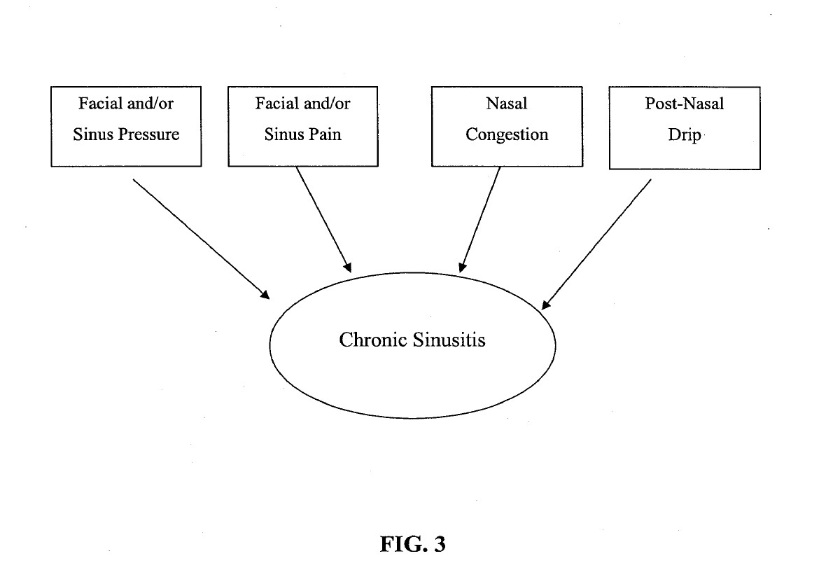

Statistical analysis was performed on the data collected from the patients described in Example 1 using their completed TSSS questionnaires. In making the statistical analyses, the mean weekly average of the patient rated daily TSSS scores were used to determine efficacy of treatment. The primary efficacy endpoint was the change from baseline (as calculated from the placebo run-in period) in the average subject-rated TSSS. The differences between the SPRC-AB01 groups and placebo were assessed using an ANCOVA model with factors for study sites, treatments, and baseline TSSS. Statistical analysis was conducted using the SAS® software package version 9 for Windows®. The change from baseline in TSSS was summarized by study day and treatment group with the appropriate descriptive statistics. The results of the clinical study are presented in FIG. 3. Based upon this analysis the following conclusions were made: (1) The 90 mg/3 ml dose of SPRC-AB01 administered B.I.D. for 21 days results in improvements in clinical signs and symptoms at the end of treatment (p=0.053), (2) Improvement was more marked the week following the end of treatment (p=0.015), (3) Two weeks post therapy showed scores in the treated group that continued to show improvement over the placebo group (p=0. 10).

### Example 3

The clinical validity of the TSSS was assessed using the mean scores of subjects in the groups classified by improvement groups based on a Physician Global Assessment using end of study data. Results from this evaluation are provided in Table 1. The results from the Physician Global Assessment support the clinical validity of both the Subject Rated and the Physician Rated TSSS.

TABLE 1

| | Physician Global Assessment | | | | | | | | | | |
|---|---|---|---|---|---|---|---|---|---|---|---|
| | Relief | | | | | | | | | | |
| | Complete | | Marked | | Moderate | | Slight | | None | | ANOVA |
| Scale (EOS) | N | Mean | N | Mean | N | Mean | N | Mean | N | Mean | P Value |
| Subject TSSS | 6 | 1.13 | 18 | 2.41 | 11 | 3.99 | 11 | 4.80 | 12 | 5.11 | <0.0001 |
| Subject TSSS Change | 6 | −4.45 | 18 | −3.78 | 11 | −3.05 | 11 | −2.16 | 12 | −1.18 | 0.0005 |
| Physician TSSS | 6 | 0.50 | 18 | 1.83 | 11 | 3.09 | 11 | 5.18 | 12 | 5.50 | <0.0001 |
| Physician TSSS Change | 6 | −4.50 | 18 | −4.50 | 11 | −3.73 | 11 | −2.00 | 12 | −0.33 | <0.0001 |

### Example 4

A Phase II, double-blind, placebo-controlled, multi-center, randomized study is conducted to evaluate the efficacy of SPRC-AB01 (Tobramycin Solution for Nasal Inhalation) in post-surgical subjects with chronic rhinosinusitis. Patients are screened for inclusion in the clinical trial using the selection criteria set forth in Example 1.

Based upon the above criteria, approximately 198 patients are selected and are enrolled into the study. The patients are divided into three patient groups: Group 1—Placebo (˜66 patients); Group 2—Low Dose—90 mg/3 ml SPRC-AB01 (˜66 Patients); and Group 3‘High Dose 180 mg/3 ml SPRC-AB01 (˜66 Patients). All groups are to be well balanced by demographics and disease severity. Each group is administered the placebo or drug composition twice a day (B.I.D) for 21 days by a nasal inhalation nebulizer.

All patients are subjected to a run-in period of between 1 to 7 days to establish a baseline value. Participating patients will take the placebo or study medication for 21 days, with 28 additional days of follow-up. Patients are required to keep a daily diary (CSSD) which includes a written questionnaire evaluating the severity of a plurality of symptoms related to chronic rhinosinusitis. Six clinical symptoms are measured by the subjective determination of the patient using the CSSD questionnaire: 1. Facial or Sinus Pressure; 2. Facial or Sinus Pain; 3. Nasal Congestion; 4. Post-Nasal drip; 5. Sinus Headache; and 6. Tiredness/Fatigue. Each symptom is scored using the symptom severity four-point scale ranging from 0-3, with 0=None, 1=Mild, 2=Moderate, and 3=Severe. Daily assessments are conducted throughout the 49 day study. In addition to the daily diaries, the patients are required to make nine clinical visits, which can include physician assessments consisting of Physician-Rated assessment of chronic sinusitis symptoms (CSS), Physician-Rated GIC scores, Physician-Rated GIS scores, nasal endoscopic exams/cultures, and/or blood sampling for peripheral eosinophils.

### Example 5

A series of analyses are conducted to examine the measurement properties of each individual clinical symptom in the CSSD. The data for each clinical symptom in the CSSD is subjected to the following analyses: (1) Missing item data; (2) Distribution of Item Responses; (3) Iter-item Correlation; (4) Item-Level Responsiveness; and (5) Construct Validity (Exploratory Factor Analysis). Based upon the results of the analyses, two or more of the individual clinical symptoms are selected for inclusion in the calculation of the TSSS composite score which will be used to determine the efficacy of the treatment regimen.

### Example 6

Statistical analysis is performed on the TSSS composite score data collected from the patients described in Example 5. In making the statistical analyses, the mean weekly averages of the TSSS composite scores are used to determine efficacy of treatment. The primary efficacy endpoint is the change from baseline in average subjected-rated TSSS composite scores during the first week post-therapy (TSSS Day 22-28). The average TSSS Day 22-28 is define as the average of the available total sinus symptom scores from the evening of Day 22 through the evening of Day 28. Weekly averages TSSS is defined in a similar manner for Days 1-7, 8-14, 15-21, 29-35, 36-42, and 43-49. The baseline TSSS is defined as the average of the non-missing TSSS values occurring during the placebo run-in period (from the evening of Day −6 to the evening of Day 0).

The differences between the SPRC-AB01 and placebo are assessed using an ANCOVA model with factors for stratification group, treatment group, and baseline TSSS. Statistical analysis is conducted using the SAS® software package version 9 for Windows®. Differences in the least square (LS) means for each active treatment and placebo are evaluated using Student's t-test with the p-values adjusted using Hochberg's method. The change from baseline in TSSS composite scores are summarized by study date and treatment group with descriptive statistics. Change from baseline in the weekly average TSSS composite scores during the first week post-therapy (Days 22-28), and endoscopic examinations, as well as their respective changes from baseline, are summarized for treatment group.

Based upon these analyses the following determinations are made: (1) Efficacy of the 90 mg/3 ml dose of SPRC-AB01 administered B.I.D. for 21 days and (2) Efficacy of the 180 mg/3 ml dose of SPRC-AB01 administered B.I.D. for 21 days.

### Example 7

A Patient exhibiting one or more of the clinical symptoms related to chronic rhinosinusitis is examined by a physician. The physician provides to the patient a daily diary (CSSD) which includes a written questionnaire evaluating the severity of a plurality of symptoms related to chronic rhinosinusitis. Seven clinical symptoms are measured by the subjective determination of the patient using the CSSD questionnaire: 1. Facial or Sinus Pressure; 2. Facial or Sinus Pain; 3. Anterior Nasal Discharge; 4. Posterior nasal discharge/post nasal drip; 5. Post-Nasal drip; 6. Sinus Headache; and 7. Tiredness/Fatigue. Each symptom is to be scored by the patient using a symptom severity four-point scale ranging from 0-3, with 0=None, 1=Mild, 2=Moderate, and 3=Severe. The patient is instructed to complete entries into the diary on a daily basis for the duration of the treatment regimen. In addition to the daily diaries, the patients are required to make nine clinical visits, which can include physician assessments consisting of Physician-Rated assessment of chronic sinusitis symptoms (CSS), Physician-Rated GIC scores, Physician-Rated GIS scores, nasal endoscopic exams/cultures, and/or blood sampling for peripheral eosinophils.

### Example 8

A series of analyses are conducted to examine the measurement properties of each individual clinical symptom in the CSSD of Example 7. The data for each clinical symptom in the CSSD is subjected to the following analyses: (1) Missing item data; (2) Distribution of Item Responses; (3) Iter-item Correlation; (4) Item-Level Responsiveness; and (5) Construct Validity (Exploratory Factor Analysis). Based upon the results of the analyses, two or more of the individual clinical symptoms are selected for inclusion in the calculation of the TSSS composite score which will be used to determine the severity of the patient's symptoms related to chronic rhinosinusitis.

### Example 9

Statistical analysis is performed on the TSSS composite score data collected from the patient described in Example 8. In making the statistical analyses, the mean weekly averages of the TSSS composite scores are used to determine the severity of the patient's symptoms related to chronic rhinosinusitis. The primary endpoint is the change from baseline in average subjected-rated TSSS composite scores from the third week (TSSS Day 14-21). The average TSSS Day 14-21 is define as the average of the available total sinus symptom scores from the evening of Day 14 through the evening of Day 21. The baseline TSSS is defined as the average of the non-missing TSSS values occurring during the first week (from the evening of Day -0 to the evening of Day 7).

The differences between the baseline and the average TSSS Day 14-21) are assessed using an ANCOVA model. Statistical analysis is conducted using the SAS® software package version 9 for Windows®. Differences in the least square (LS) means for each active treatment and placebo are evaluated using Student's t-test with the p-values adjusted using Hochberg's method. Change from baseline in the weekly average TSSS composite score during the third week (Days 14-21), and endoscopic examinations, as well as their respective changes from baseline, are summarized determined.

Based upon these analyses the physician compares the patient's TSSS scores with known diagnostic criteria to make the following determination: (1) The patient has severe chronic rhinosinusitis; (2) The patient has mild chronic rhinosinusitis; (3) The patient does not have chronic rhinosinusitis. With this determination in mind, the physician determines the appropriate treatment regimen for the patient.

What is claimed is:

1. A method for determining the efficacy of a treatment regimen for chronic rhinosinusitis, said method comprising the steps of:
(a) conducting at least two interviews of one or more patients over the duration of a treatment regimen to collect patient-reported information specific to clinical severity of one or more of a plurality of symptoms related to chronic rhinosinusitis in said one or more patients;
(b) said at least two interviews comprising said one or more patients assigning an individual symptom score for each of said one or more symptoms within said plurality of symptoms at the time of said interviews;
(c) selecting two or more individual symptoms of said plurality of symptoms for use in calculating a composite score which reflects clinical status of said chronic rhinosinusitis in said one or more patients at the time said interview was conducted;
(d) calculating a composite score based upon the value of said two or more individuals symptoms of step (c) to obtain a sum value which reflects the clinical status of said chronic rhinosinusitis in said patient at the initiation of said treatment regimen;
(e) calculating a composite score based upon the value of said two or more individuals symptoms of step (c) to obtain a sum value which reflects the clinical status of said chronic rhinosinusitis in said patient at a time point after the initiation of said treatment regimen; and
(f) comparing sum values of steps (d) and (e) to determine the efficacy of said treatment regimen.

2. The method of claim 1, wherein said interviews are conducted daily over the duration of said treatment regimen.

3. The method of claim 1, wherein said interviews comprise collecting said patient-reported information in the form of responses to a set of oral questions, collecting said patient-reported information in the form of responses to a set of questions contained in written questionnaire, collecting said patient-reported information in the form of responses to a set of questions in a telephone survey, collecting said patient-reported information in the form of responses to a set of questions in fax survey, collecting said patient-reported information in the form of responses to a set of questions in an Internet questionnaire to be submitted via the Internet, or by having said one or more patients directly input their responses to a set of questions contained in a questionnaire into a computer database.

4. The method of claim 1, wherein said interviews comprise collecting patient-reported information in the form of patient responses to a set of questions contained in a written questionnaire.

5. The method of claim 1, wherein said plurality of symptoms related to chronic rhinosinusitis comprises at least one of: (1) facial or sinus pressure, (2) facial or sinus pain, (3) nasal congestion, (4) postnasal drip, (5) sinus headache, and (6) tiredness/fatigue.

6. The method of claim 1, wherein said individual symptom score comprises a subjective self-assessment of the symptom translated to a number for each of said plurality of symptoms related to chronic rhinosinusitis.

7. The method of claim 6, wherein the number is selected from an individual symptom score scale representative of the clinical status of the chronic rhinosinusitis symptom being assessed.

8. The method of claim 6, wherein said individual symptom score scale comprises a four point scale that is divided in increments of 1.

9. The method of claim 7, wherein said individual symptom score scale further comprises a numerical value corresponding to the severity of the symptom; 0 being no indication of the symptom (none), 1 being mild indication of the symptom (mild), 2 being moderate indication of the symptom (moderate), and 3 being severe indication of the symptom (severe).

10. The method of step (c) of claim 1, wherein said two or more individual symptoms are selected for use in said calculating composite score based upon the validation of each of said at least two individual symptoms' relevance to said clinical severity of chronic rhinosinusitis in said one or more patients.

11. The method of claim 10, wherein said validation is determined by statistical analysis of the patent-reported information of steps (a) and (b).

12. The method of claim 1 step (c), wherein two individual symptoms are selected for use in calculating said composite score.

13. The method of claim 1 step (c), wherein three individual symptoms are selected for use in calculating said composite score.

14. The method of claim 1 step (c), wherein four individual symptoms are selected for use in calculating said composite score.

15. The method of claim 1 step (c), wherein five individual symptoms are selected for use in calculating said composite score.

16. The method of claim 1 step (c), wherein six individual symptoms are selected for use in calculating said composite score.

17. The method of claim 1 step (d), wherein said calculating a composite score comprises adding together the individual symptom scores of said two or more individual symptoms selected in step (c) to obtain a sum value which reflects the clinical status of said chronic rhinosinusitis in said one or more patients at the initiation of said treatment regimen.

18. The method of claim 1 step (e), wherein said calculating a composite score comprises adding together the individual symptom scores of said two or more individual symptoms selected in step (c) to obtain a sum value which reflects the clinical status of said chronic rhinosinusitis in said one or more patients at a time point after the initiation of said treatment regimen.

19. The method of claim 1, wherein step (f) comprises calculating the p value of the change in composite scores of steps (d) and (e) in a patient population as compared to the change in composite scores of steps (d) and (e) in a patient population given a placebo or an alternate therapy.

20. The method of claim 1, wherein step (f) comprises identifying said treatment regimen as highly effective, effective, moderately effective, or not effective.

21. The method of claim 1, wherein said treatment regimen comprises the administration of an active agent at a specific dosage for the treatment of chronic rhinosinusitis over a defined period of time.

22. The method of claim 1, wherein said method is used to compare the efficacy of one or more distinct dosages of an active agent in treating chronic rhinosinusitis.

23. The method of claim 1, wherein said method is used to compare the efficacy of one or more distinct active agents in treating chronic rhinosinusitis.

24. The method of claim 1, further comprising building a predictive model to determine a patient's healthcare outcome to a particular treatment regimen.

25. The method of claim 1, further comprising building a predictive model to determine a patient population's healthcare outcome to a particular treatment regimen.

26. A method for the assessment of chronic rhinosinusitis, said method comprising the steps of:
(a) conducting at least two interviews of with said one or more patients over the duration of a treatment regimen to collect patient-reported information specific to clinical severity of one or more of a plurality of symptoms related to chronic rhinosinusitis in said one or more patients;
(b) said at least two interviews comprising said one or more patients assigning an individual symptom score for each of said one or more symptoms within said plurality of symptoms at the time of said interview;
(c) selecting two or more individual symptoms of said plurality of symptoms for use in calculating a composite score which reflects clinical status of said chronic rhinosinusitis in said one or more patients at the time said interview was conducted;
(d) calculating a composite score based upon the value of said two or more individuals symptoms of step (c) to obtain a sum value which reflects clinical status of said chronic rhinosinusitis in said patient at the initiation of said treatment regimen;
(e) calculating a composite score based upon the value of said two or more individuals symptoms of step (c) to obtain a sum value which reflects clinical status of said chronic rhinosinusitis in said patient at a time point after the initiation of said treatment regimen;
(f) comparing sum values of steps (d) and (e) to assess chronic sinusitis in said one or more patients.

27. The method of claim 26, wherein said interviews are conducted daily over the duration of said treatment regimen.

28. The method of claim 26, wherein said interviews comprise collecting said patient-reported information in the form of responses to a set of oral questions, collecting said patient-reported information in the form of responses to a set of questions contained in written questionnaire, collecting said patient-reported information in the form of responses to a set of questions in a telephone survey, collecting said patient-reported information in the form of responses to a set of questions in fax survey, collecting said patient-reported information in the form of responses to a set of questions in an Internet questionnaire to be submitted via the Internet, or by having said one or more patients directly input their responses to a set of questions contained in a questionnaire into a computer database.

29. The method of claim 26, wherein said interviews comprise collecting patient-reported information in the form of patient responses to a set of questions contained in a written questionnaire.

30. The method of claim 26, wherein said plurality of symptoms related to chronic rhinosinusitis comprises at least one of: (1) facial or sinus pressure, (2) facial or sinus pain, (3) nasal congestion, (4) postnasal drip, (5) sinus headache, and (6) tiredness/fatigue.

31. The method of claim 26, wherein said individual symptom score comprises a subjective self-assessment of the symptom translated to a number for each of said plurality of symptoms related to chronic rhinosinusitis.

32. The method of claim 31, wherein the number is selected from an individual symptom score scale representative of the clinical status of the chronic rhinosinusitis symptom being assessed.

33. The method of claim 32, wherein said individual symptom score scale comprises a four point scale that is divided in increments of 1.

34. The method of claim 33, wherein said individual symptom score scale further comprises a numerical value corresponding to the severity of the symptom; 0 being no indication of the symptom (none), 1 being mild indication of the symptom (mild), 2 being moderate indication of the symptom (moderate), and 3 being severe indication of the symptom (severe).

35. The method of step (c) of claim 26, wherein said two or more individual symptoms are selected for use in said calculating composite score based upon the validation of each of said at least two individual symptoms' relevance to said clinical severity of chronic rhinosinusitis in said patient.

36. The method of claim 35, wherein said validation is determined by statistical analysis of the patent-reported information of steps (a) and (b).

37. The method of claim 26, wherein the assessment of chronic rhinosinusitis comprises assessing the response of a patient to a particular treatment regimen.

38. The method of claim 26, wherein the assessment of chronic rhinosinusitis comprises assessing the response of a patient population to a particular treatment regimen.

39. The method of claim 26, further comprising the step (g) of comparing the composite scores of step (f) to a previously calculated composite score from the same patient.

40. The method of claim 39, wherein comparing the composite score to a previously calculated composite score from the same patient further comprises calculating the difference between the composite score and a previously calculated composite score from the same patient.

41. The method of claim 26, further comprising calculating the difference between a mean composite score in a patient population and a previously calculated mean composite score in the same patient population.

42. A method for determining the severity of symptoms related to chronic rhinosinusitis in a patient, said method comprising the steps of:
(a) conducting at least two interviews of with said patient over the duration of a pre-determined period of time to collect patient-reported information specific to the clinical severity of one or more of a plurality of symptoms related to chronic rhinosinusitis;
(b) said at least two interviews comprising said patient assigning an individual symptom score for each of said one or more symptoms within said plurality of symptoms at the time of said interview;
(c) selecting two or more individual symptoms of said plurality of symptoms for use in calculating a composite score which reflects clinical status of said chronic rhinosinusitis in said patient at the time said interview was conducted;
(d) calculating a composite score based upon the value of said two or more individuals symptoms of step (c) to obtain a sum value which reflects clinical status of said chronic rhinosinusitis in said patient at the time of the first interview;
(e) calculating a composite score based upon the value of said two or more individuals symptoms of step (c) to obtain a sum value which reflects clinical status of said chronic rhinosinusitis in said patient at a time point after the first interview;
(f) comparing sum values of steps (d) and (e) to determine the severity of the symptoms related to chronic rhinosinusitis in said patient.

43. The method of claim 42, wherein said interviews are conducted daily over the duration of said predetermined period of time.

44. The method of claim 42, wherein said interviews comprise collecting said patient-reported information in the form of responses to a set of oral questions, collecting said patient-reported information in the form of responses to a set of questions contained in written questionnaire, collecting said patient-reported information in the form of responses to a set of questions in a telephone survey, collecting said patient-reported information in the form of responses to a set of questions in fax survey, collecting said patient-reported information in the form of responses to a set of questions in an Internet questionnaire to be submitted via the Internet, or by having said one or more patients directly input their responses to a set of questions contained in a questionnaire into a computer database.

45. The method of claim 42, wherein said interviews comprise collecting patient-reported information in the form of patient responses to a set of questions contained in a written questionnaire.

46. The method of claim 42, wherein said plurality of symptoms related to chronic rhinosinusitis comprises at least one of: (1) facial or sinus pressure, (2) facial or sinus pain, (3) nasal congestion, (4) postnasal drip, (5) sinus headache, and (6) tiredness/fatigue.

47. The method of claim 42, wherein said individual symptom score comprises a subjective self-assessment of the symptom translated to a number for each of said plurality of symptoms related to chronic rhinosinusitis.

48. The method of claim 47, wherein the number is selected from an individual symptom score scale representative of the clinical status of the chronic rhinosinusitis symptom being assessed.

49. The method of claim 47, wherein said individual symptom score scale comprises a four point scale that is divided in increments of 1.

50. The method of claim 48, wherein said individual symptom score scale further comprises a numerical value corresponding to the severity of the symptom; 0 being no indication of the symptom (none), 1 being mild indication of the symptom (mild), 2 being moderate indication of the symptom (moderate), and 3 being severe indication of the symptom (severe).

51. The method of step (c) of claim 42, wherein said two or more individual symptoms are selected for use in said calculating composite score based upon the validation of each of said at least two individual symptoms' relevance to said clinical severity of chronic rhinosinusitis in said patient.

52. The method of claim 51, wherein said validation is determined by statistical analysis of the patient-reported information of steps (a) and (b).

53. The method of claim 42, further comprising the step (g) of comparing the composite score to known diagnostic criteria.

54. The method of claim 53, wherein comparing the composite score to known diagnostic criteria further comprises statistical analyses.

55. The method of claim 53, further comprising comparing the composite score to known diagnostic criteria in a lookup table.

56. The method of claim 53, further comprising a determination of whether chronic rhinosinusitis in a patient is in a mild, moderate, or severe stage of disease progression.
